(19) United States
(12) Patent Application Publication
(10) Pub. No.: US 2011/0050119 A1
(43) Pub. Date: Mar. 3, 2011

(54) Light-Emitting Diode Light Rod With Screw Head

(76) Inventor: Wen-Cheng Lai, Taoyuan (TW)

(21) Appl. No.: 12/548,421

(22) Filed: Aug. 26, 2009

(51) Int. Cl. H05B 37/02

(52) U.S. Cl. 315/294

(57) ABSTRACT

A light-emitting diode(LED) light rod with screw head is provided, including a circuit board having a plurality of LED lights distributed evenly on the surface; a screw head further including an insulated main body and a metal screw shell, the inside of main body having a control circuit for electrical connection with the screw shell and circuit board respectively, the screw shell matching the conventional socket base for tungsten light bulb in a conventional light string, and control circuit for transforming household alternating current (AC) into direct current (DC) for LED lights; and a rod shell, for the light to shine through and for housing the circuit board, the rod shell having one end closed and the other end connected to the main body of the screw head.

### FIELD OF THE INVENTION

The present invention generally relates to a light-emitting diode (LED) lighting device, and more specifically to an LED light rod with a screw head to draw power from a conventional base for tungsten light bulb, applicable for decorative and lighting purposes.

### BACKGROUND OF THE INVENTION

The light string made of conventional tungsten light bulbs is widely used because of high luminance. Each light bulb of this type of light string includes a metal screw head at the bottom so as to screw in a socket base. However, as the conventional tungsten light bulb has the disadvantages of high power-consumption, short life-span, fragility, and so on, more and more LED strings are developed to replace the conventional tungsten light bulb strings. LED lights have the advantages of long life-span, low power-consumption and small size.

Hence, how to design an LED lighting device suitable for power socket for conventional light strings to draw power from the common household AC power is an imperative design issue for the industry.

### SUMMARY OF THE INVENTION

The primary object of the present invention is to provide a LED light rod with screw head for installation in conventional light bulb socket base.

Another object of the present invention is to provide an LED light rod that can be used in plurality to form LED light string or other formation for hanging or standing on the ground for decorative and lighting purposes.

Yet another object of the present invention is to provide an LED light rod, for substituting the tungsten light bulbs on a conventional light string so as to form a hybrid light string with tungsten light bulbs and LED lights to provide various visual effects.

To achieve the aforementioned objects, the present invention is to provide an LED light rod with screw head, including a circuit board having a plurality of LED lights distributed evenly on the surface; a screw head further including an insulated main body and a metal screw shell, the inside of main body having a control circuit for electrical connection with the screw shell and circuit board respectively, the screw shell matching the conventional socket base for tungsten light bulb in a conventional light string, and control circuit for transforming household alternating current (AC) into direct current (DC) for LED lights; and a rod shell, for the light to shine through and for housing the circuit board, the rod shell having one end closed and the other end connected to the main body of the screw head.

As the assembled LED light rod of the present invention includes a screw head, a plurality of LED light rods can be screwed to the socket bases for light bulbs in a light string to form an LED light string. The LED light string can be hanged on trees, other objects or placed on the ground to for lighting or decorative purposes.

Furthermore, the present invention may include a base dock of any design. The base can include a plurality of socket bases for screwing the LED light rod of the present invention to form any specific design for style.

Because the screw head of the present invention is the same the screw head of the conventional tungsten light bulb, a conventional light string can include both tungsten light bulbs and the LED light rods of the present invention to achieve various visual effects.

In addition, a control IC can be included for controlling the color or lighting of the LED lights, such as, flashing, dimming, light in groups, and so on to allow further variations of lighting patterns.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a dissected view of an embodiment of an LED light rod with screw head according to the present invention;

FIG. 2 shows an assembled view of an embodiment of an LED light rod with screw head according to the present invention;

FIG. 3 shows a schematic view of an embodiment of the control circuit of an LED light rod with screw head according to the present invention;

FIG. 4 shows an embodiment of an actual application of the present invention;

FIG. 5 shows an embodiment of another actual application of the present invention;

FIG. 6 shows an embodiment of yet another actual application of the present invention; and

FIG. 7 shows an embodiment of yet another actual application of the present invention.

### DETAILED DESCRIPTION OF THE PREFERRED EMBODIMENTS

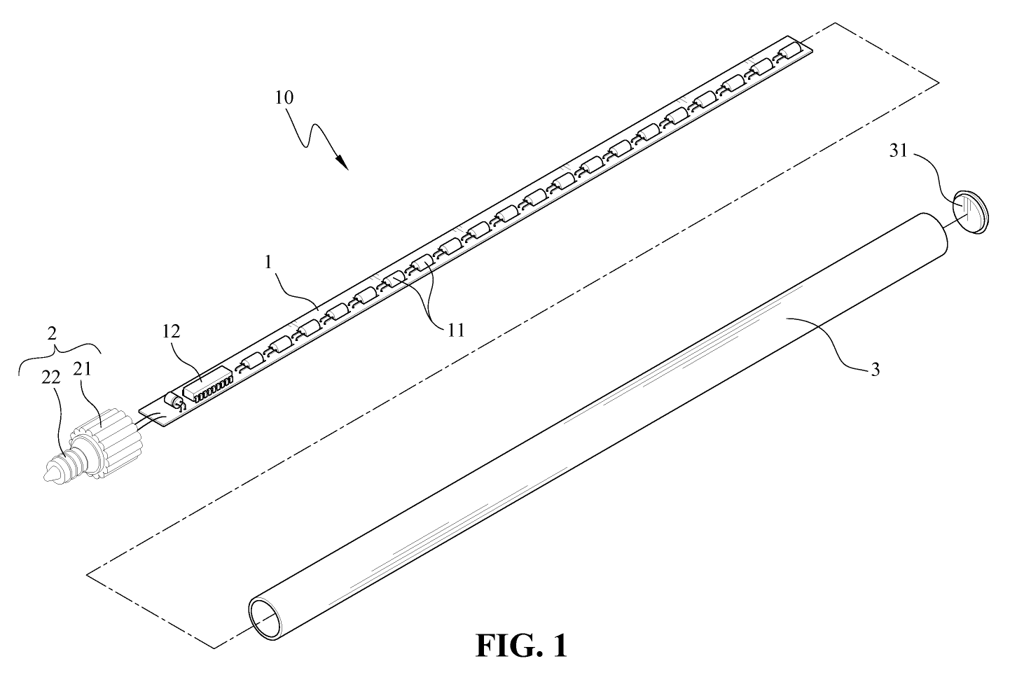

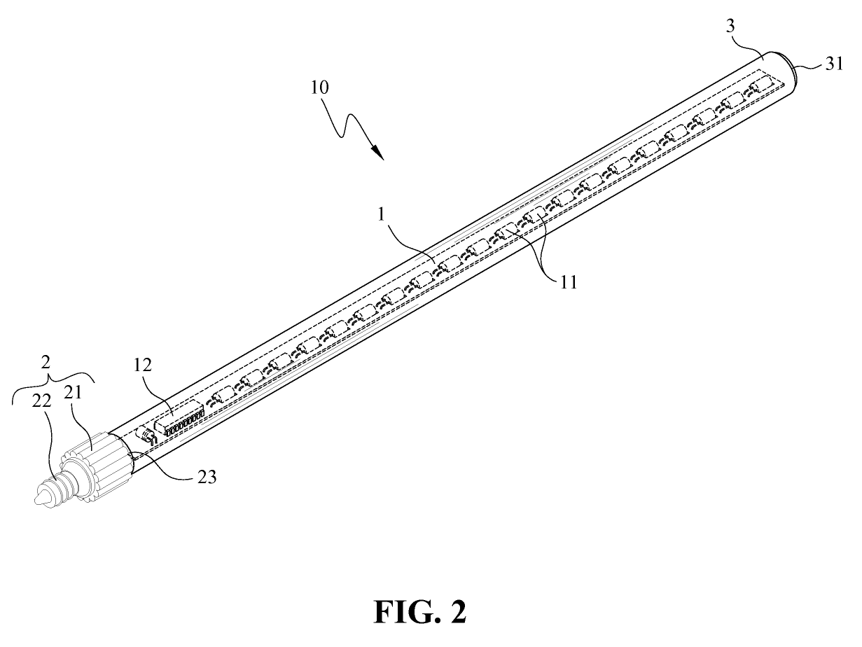

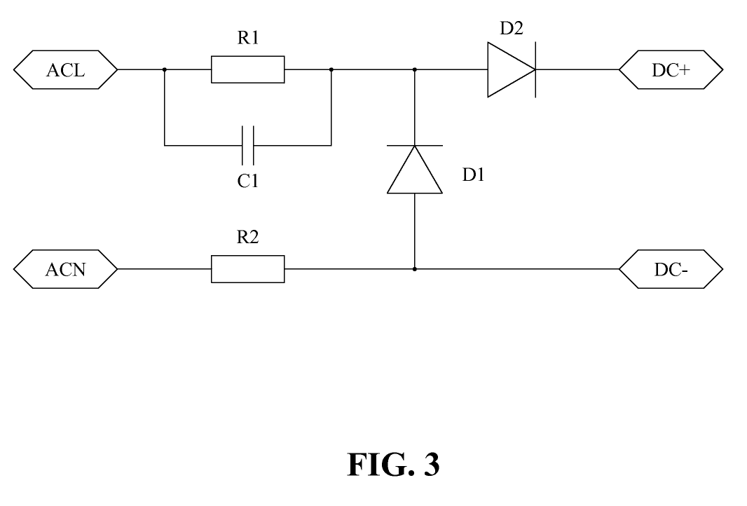

FIG. 1 and FIG. 2 show a schematic dissected view and assembled view of an LED light rod with screw head according to the present invention, respectively. An LED light rod 10 includes a long circuit board 1, with a plurality of LED lights 11 evenly distributed on the surface, and a control IC 12 for controlling the color and lighting of LED lights 11. Circuit board 11 is electrically connected to a screw head 2. Screw head 2 includes an insulated main body 21 and a metal screw shell 22. Main body 21 has a control circuit (FIG. 3) inside for transforming the household AC into DC for LED lights. The input wire of the control circuit touches the inner wall of metal screw shell 22. The inside of main body 21 includes insulation heat-resist material (not shown), and a combustion-supporting material 23 to seal the control circuit inside main body 21. Circuit board 1 is housed inside a rod shell 3. Rod shell 3 is made of material for light to shine through. One end of rod shell 3 can be closed in a monolithic formation, or a cover 31 can be used to seal this end. The other end of rod shell 3 is sealed by main body 21 so that metal screw shell 22 is exposed outside of rod shell 3 to form an LED light rod 10 with a screw head.

The transformation of AC into DC is shown in FIG. 3. As the common household plug supplies AC, and the LED light requires DC to operate, the present invention includes a control circuit inside main body 21 of screw head 2 to provide the function of transforming AC into DC. The ACL of the control circuit is the input end. Another input end CAN is connected to a resistor R2 with capability for suppressing surge in the circuit. After the current passes resistor R1 and capacitor C1 of the filter, and passes diodes D1, D2, the output current become DC required by decorative light strings.

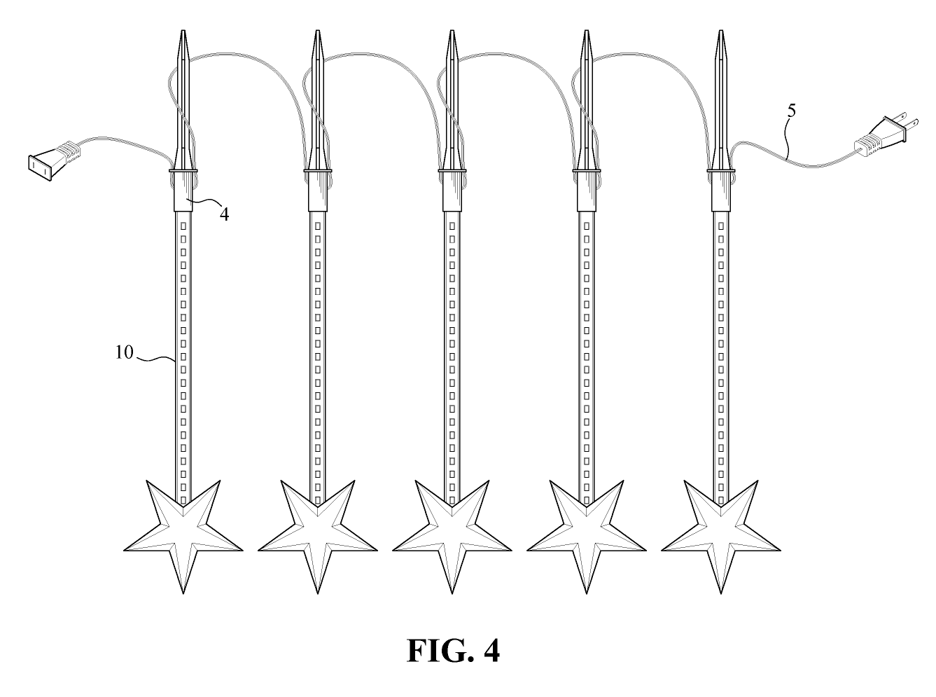

FIG. 4 shows an actual application of the LED light rod with screw head according to the present invention. As shown in FIG. 4, a plurality of socket bases 4 is included. Each socket base 4 includes inner screw teeth (not shown). All socket bases 4 are electrically connected in series through a wire 5 with a plug and a socket on each end, respectively, for connecting in series with other sockets. A plurality of LED light rods 10 is screwed into socket base 4 with metal screw shell 22 (FIG. 1) to form an LED light string. The formed light string can be hanged on a tree or other object. Alternatively, the sharp end of the socket can be stuck into the ground soil so that the LED light rod can stand on the ground. The closed end of rod shell 3 (FIG. 1) can form a star shape or other design to increase the esthetics.

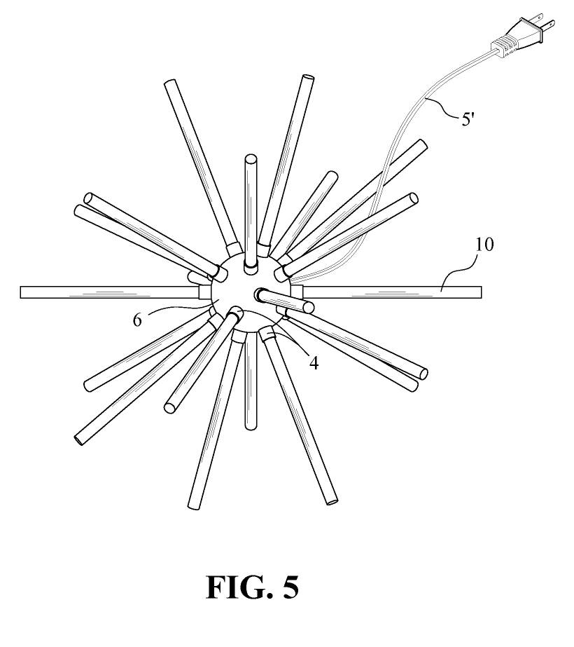

FIG. 5 shows another embodiment of the LED light rod with screw head according to the present invention. A base dock 6 of any design can be used. In the embodiment, base dock 6 is shaped as a ball. Base dock 6 is connected to a wire 5′. A plurality of socket bases 4 with screw holes is evenly distributed on base dock 6. An LED light rod 10 is screwed into socket base 4 to form a three-dimensional light string. In combination with the color and lighting changes of LED lights 11 (FIG. 1), the three-dimensional light string can be hanged in the air to achieve magnificent visual effects.

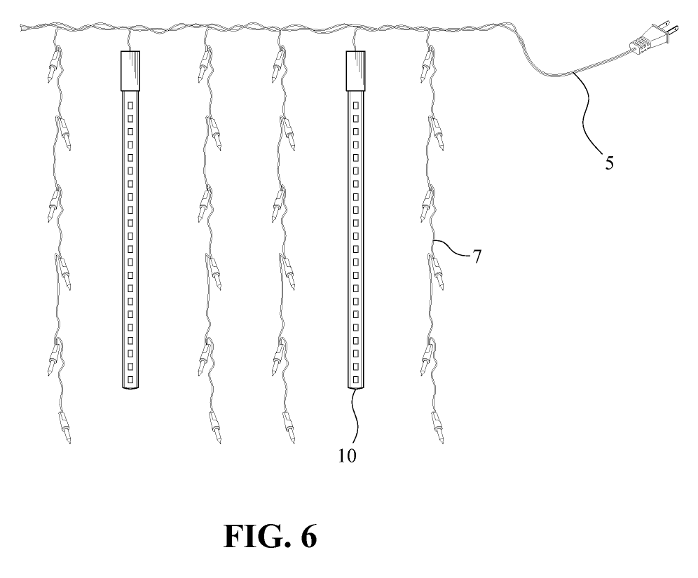

FIG. 6 shows yet another embodiment of the LED light rod with screw head according to the present invention. Because LED light rod 10 has the same metal screw shell 22 (FIG. 1) as the screw head of the tungsten light bulb of conventional light string, the LED light rod can replace the tungsten light bulb when the tungsten light bulb is burnt out. In this embodiment, a wire 5 with a plug and a socket on each end, respectively, is used to electrically connect the conventional tungsten light bulb 7 and LED light rod 10 in series. The hybrid light string provides more variations of light colors and patterns.

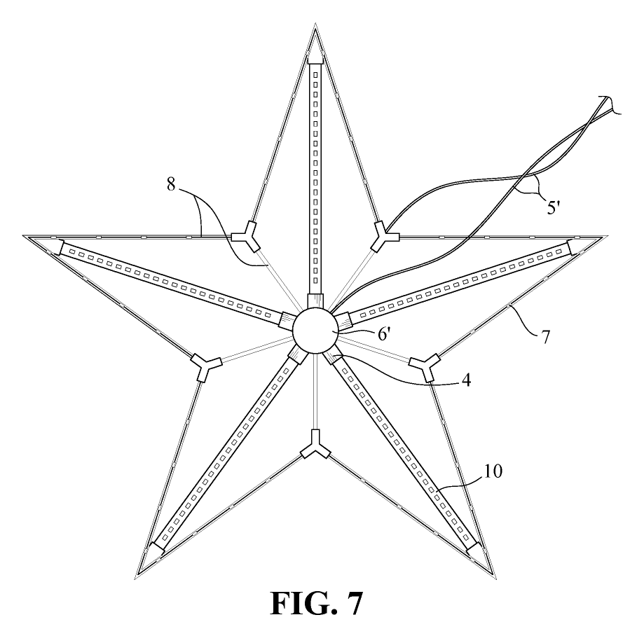

FIG. 7 shows another embodiment of the LED light rod with screw head according to the present invention. As the embodiment of FIG. 5, the present embodiment uses a base dock 6′ of a puck shape. Base dock 6′ is electrically connected to a wire 5′. A plurality of socket bases 4 is arranged on base dock 6′ in a radiation manner. An LED light rod 10 is screwed into a socket base 4. Additional transparent rods 8 are used to form a star pattern with LED light rods 10. Conventional tungsten light strings 7 can be placed surrounding transparent rods 8 to add additional illumination effects.

In summary, the LED light rod of the present invention has a screw head identical to the screw head of the conventional tungsten light bulb so that the LED light rod can be used with the conventional socket base. In this manner, the LED light rod can replace the conventional tungsten light bulb as well as used in plurality to form variations of illumination patterns to achieve desired visual effects.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A light-emitting diode (LED) light rod with screw head, comprising:
a circuit board, having a plurality of LED lights evenly distributed on surface of said circuit board;
a screw head, further comprising an insulated main body and a metal screw shell, inside of said main body having a control circuit, said control circuit being electrically connected to said screw shell and said circuit board so as to transform input alternating current (AC) into direct current (DC) required by said LED lights; and
a rod shell, allowing light to shine through, for housing said circuit board, said rod shell having one end sealed and the other end collected to said main body of said screw head.

2. The LED light rod with screw head as claimed in claim 1, wherein said control circuit further comprises a control IC for controlling the color and lighting patterns of said LED lights.
